(19) United States
(12) Patent Application Publication
(10) Pub. No.: US 2015/0225301 A1
(43) Pub. Date: Aug. 13, 2015

(54) Metal-Ceramic Nanocomposites With Iron Aluminide Metal Matrix And Use Thereof As Protective Coatings For Tribological Applications

(71) Applicant: HYDRO-QUÉBEC, Montréal (CA)

(72) Inventors: Robert Schulz, Ste-Julie (CA); Simon Gaudet, Gatineau (CA); Sylvio Savoie, Sainte-Julie (CA)

(21) Appl. No.: 14/429,209

(22) PCT Filed: Sep. 6, 2013
(86) PCT No.: PCT/CA2013/050684

§ 371 Date: Mar. 18, 2015

(30) Foreign Application Priority Data
Sep. 19, 2012 (CA) 2,790,764

(51) Int. Cl. C04B 35/622; C04B 35/626; C04B 35/58; C23C 24/08

(52) U.S. Cl. CPC C04B 35/62222; C23C 24/08; C04B 35/6261; C04B 35/58071; C04B 35/5805

(57) ABSTRACT

The invention relates to an improved composite material comprising a metal matrix component containing Fe and Al and a ceramic component containing refractory hard metals and metalloids or non-metal elements. The ceramic component consists of ceramic nanoparticles whose dimension are below 100 nm. It also relates to a method of preparing this composite material in the form of a coating, which consists of using a thermal spray technique and a powder which is synthesized by high energy mechano-chemical reactions between the components of the composite. The ceramic component of the composite is formed in situ. The above composite material is particularly useful as protective coatings for tribological applications.

### FIELD OF INVENTION

The present invention relates to an improved composite material comprising a metal matrix component containing Fe and Al and a ceramic component containing refractory hard metals and metalloids or non-metal elements.

The present invention also relates to a method of preparing this improved composite material in the form of a coating which consists of using a thermal spray technique and a powder which is synthesized by high energy mechanochemical reactions between the components of the composite.

The present invention further relates to the use of such composite material as protective coatings for tribological applications.

### TECHNOLOGICAL BACKGROUND

Composites having metal or intermetallic matrix and ceramic components containing refractory hard metals of the group IV, V and VI of the Periodic Table and non-metals such as carbon, boron, nitrogen, oxygen, silicon, phosphorous and sulphur are known since a long time. The conventional powder metallurgy route to produce these composites usually involves mixing, blending or ball milling at low energy the metal powder with the pre-synthesized ceramic powder, pressing the powder mixture to form a green compact and finally, sintering at high temperature the material in the solid or liquid phase to form a dense piece with low porosity or alternatively pressing directly at high temperature the powder mixture to form a compact. If a coating instead of a bulk piece is required, techniques such as plasma spray have been used. The conventional route often requires complex and expensive equipments for consolidation and the availability of small ceramic particles which are also quite expensive. The general belief is that the small particle size leads to final products with better properties and greater ductility.

To improve over the conventional technique, U.S. Pat. No. 4,916,029 in the name of D.C. Nagle et al. issued in 1990 proposed to use a self-propagating high temperature synthesis process (SHS) to form in-situ the ceramic component. For instance, a mixture of pure aluminium, titanium and boron powder is blended, compacted and heated above the melting point of aluminum to ignite an aluminothermic reaction which produces a titanium aluminide intermetallic matrix (Al₃Ti) incorporating titanium diboride ceramic particles (TiB₂) according to the following reaction:

3 Al+2 Ti+2 B+Ignition=>Al₃Ti+TiB₂ (large heat released)

The same technique has been extended in U.S. Pat. No. 5,059,490 in the name of the same inventors to include in-situ precipitation of complex ceramic whiskers such as TiNbB in a metal matrix. However, these SHS reaction are almost impossible to control once ignited. Indeed, they produce a thermal spike where extremely high temperatures are achieved in a very short period of time resulting in an extremely rapid formation of the final products. The large heat release can cause metal to be splattered or sprayed from the containment vessel and the reaction can sometimes be so violent that the vessel can be destroyed by the thermal shock. The end product is most of the time highly porous, inhomogeneous and the particle size distribution is wide and almost impossible to control. Indeed, the temperature profile (heating and cool-down period) which affect strongly the particle size is very difficult to control in such a process. Even though the preferred grain size of these inventors ranges between 0.01 and 5 microns, the real size achieved by such a technique is between 0.1 and 2 microns or larger. Moreover, this process for forming composite materials is not really applicable to materials in powder form.

In parallel to these developments, U.S. Pat. No. 4,961,903 in the name of McKamey et al. reports an iron aluminide alloy with improved room temperature ductility obtained by the additions of various alloying constituents such as Cr and B to an iron aluminide base alloy of composition near Fe₃Al. The improved alloy has good oxidation resistance and high strength at elevated temperature. Moreover, iron aluminide based alloys of the formula Fe₃₋ₓAl₁₊ₓM_{y}T_{z} where M represents at least one catalytic specie such as Ru and T, an element such as Cr, Mo and Nb have also been disclosed recently as efficient cathodic materials for the synthesis of sodium chlorate (see CA 2,687,129 of 2011). These iron-aluminide alloys have shown improved corrosion resistance in various environmental conditions and particularly, in concentrated HCl solutions. The corrosion resistance is in most part, associated to the presence of elements such as Cr and Nb in the alloy. These compounds are also resistant to oxidation and in particular at high temperature due to the presence of Al which forms a thin protective alumina layer on the surface. These alloys are usually single phase materials. They are solid solutions in a stable or metastable state and they can be prepared in a nanocrystalline form by various techniques such as rapid quenching or high energy ball milling. When thermal spray is used to prepare coatings of this last material, a good protection of the coated substrate against corrosion can be achieved at reasonable cost.

However, the mechanical and tribological properties (hardness, wear and erosion resistance etc.) of these corrosion resistant iron aluminide based materials are not particularly good and therefore, need to be improved. In this regard, composites having an improved iron aluminide base matrix with a well dispersed second phase ceramic with very small particle size distributed homogenously throughout the matrix would be highly desirable. The smaller the particle size and the more homogenous is the distribution of the ceramic phase within the metal matrix, the better are the tribological properties.

U.S. Pat. No. 5,637,816 in the name of J.H. Schneibel reports a metal matrix composite comprising an iron aluminide binder phase and a ceramic particulate phase such as TiB₂ or TiC made by a conventional liquid phase sintering process which consists of mixing relatively coarse powders (10-50 μm) of iron aluminide and ceramic, cold-pressing the mixture and heating the compacted product to a temperature sufficient to melt the iron-aluminide matrix. For instance, a temperature of 1450 C was chosen when the melting point of the iron aluminide matrix is 1417 C for the composition of 24.4 wt % aluminium. The inventors mentioned that milling of the powder prior to fabrication is not necessary. The inventors claim that this metal matrix composite can be used as coatings for wear parts and cutting tools and has good abrasion resistance but the large particle sizes and high processing temperatures which lead to grain growth suggest that significant improvement over this prior art would be beneficial.

More recently U.S. Pat. No. 6,489,043 B1 in the name of Deevi et al. reports an iron aluminide fuel injector component which has good oxidation, corrosion and wear resistance. The iron aluminide alloy may contain up to 5 wt % of transition and refractory elements such as Ti, Cr, Mo, Zr and boron and carbon in amounts sufficient to form borides (˜0.02 wt % B) and carbides (˜0.5 wt % C). The material is made by conventional metallurgical processes such as casting from the liquid phase and hot extrusion, metal injection molding or compaction and sintering of conventional or nanosized powders. Because it contains boron and carbon, the sintered iron aluminide alloy can include ceramic particles. The material can also be made as coating using various processes such as plasma spray, physical and chemical vapour deposition and diffusion reaction. Since conventional processes are used to prepare these iron aluminide components, the microstructures are coarse and properties are similar to those reported in the previous arts.

In 2010, G. Rosas et al. reported in Acta Microscopica vol. 19, no.3, the formation of FeAl—BN nanocomposite by mechanical alloying. In a first step, they produced nanocrystalline iron aluminide intermetallic by milling elemental Fe and Al powders together. In a second step, they milled the BN powder independently to produce nanostructured BN and in a final step, they milled the iron aluminide nanocrystalline powder with the boron nitride nanostructured powder to achieve fine dispersion of BN particles in the FeAl matrix thus forming an intermetallic-ceramic nanocomposite. The powder mixture was milled using ethanol as process-control agent to prevent cold welding between the components. After milling, each component retained their nanostructural features and there was no evidence of formation of other phases. This process is to some extent similar to the conventional metallurgical process of mixing metal and ceramic components except that in the present case, both starting components are nanocrystalline and the mixing is performed in a high energy ball mill to achieve an ultra fine dispersion of the constituents. Such method is expensive since it involves several processing steps and it requires the availability of ceramic particles as in most of the methods discussed previously.

From this analysis of the prior art related to metal-ceramic composites based on aluminide intermetallic matrices and ceramic particles which combine refractory hard metals of the group IV, V and VI (Ti, Zr, Hf, V, Nb, Ta, Cr, Mo, W) and metalloids or non-metals such as (B, C, N, O, Si, P, S), we conclude that there is a need for an improved method of fabrication of a composite which comprises an in-situ formation process of borides, carbides, nitrides, oxides, silicides, phosphides and sulfides in a controlled manner. There is also a need for an improved low cost wear resistant composite material which includes extremely fine ceramic particles (below 0.1 μm) having a narrow particle size distribution well dispersed in an iron aluminide matrix which itself is highly resistant to corrosion in various environmental conditions.

In parallel to the developments mentioned earlier on methods of synthesis, interesting findings have been observed recently in the field of mechanochemistry. Indeed, researchers have discovered that it was possible to induce several chemical reactions between wide varieties of compounds with the help of severe mechanical deformations. These mechanochemical reactions are activated by the presence of defects such as dislocations, grain boundaries and vacancies created by the deformation processes. When a mixture of two powders is milled intensively at high energy in a ball mill without process-control agent, cold-welding between particles takes place. Fresh interfaces free of oxide are formed between the components. The powder particles entrapped between the colliding balls react at their interfaces and form new products. This mechanically assisted reaction is gradual and easy to control. It depends directly on the intensity of milling, the milling time and on the nature of the components.

### SUMMARY OF THE INVENTION

As an improvement over the prior art related to metal-ceramic composites based on iron aluminide matrices, the present invention is directed to a new method of synthesis which consist of using mechanochemical displacement reactions to precipitate the ceramic components in-situ by milling intensively powder mixtures of iron aluminide, refractory hard metals and non-metal elements. The non-metal component or metalloid is preferably introduced into the alloy during fabrication by the addition of a solid lubricant. Examples of solid lubricant are boron nitride (BN), graphite (C), graphite fluoride, fullerene, molybdenum and tungsten disulfide (MoS₂, WS₂), calcium and cerium fluoride (CaF₂, CeF₃), talc, PTFE etc. The addition of solid lubricant usually helps reducing the sticking problems in the milling crucible. The lubricant material reacts with the other components of the alloy to form the ceramic component in situ during the milling process. For instance, when BN is used as solid lubricant and the powder mixture contains Ti, the boron component of BN reacts with Ti during milling to form titanium diboride (TiB₂) and the nitrogen component of BN reacts with Al of the iron-aluminide matrix to form aluminium nitride (AlN). This unexpected finding is very useful because the ceramic components (TiB₂ and AlN) are formed in-situ, they are of very small size (nanometric dimensions, <100 nm), highly dispersed within the iron-aluminide matrix and they provide good tribological properties to the final product (hardness, wear resistance etc). If no refractory metal is added to the powder mixture and the same milling experiment takes place between iron-aluminide and the solid lubricant, BN, the boron component of BN reacts with Fe of the iron-aluminide matrix to form Fe boride (Fe₂B) and the nitrogen component of BN reacts with Al of the iron-aluminide matrix as before to form aluminium nitride (AlN). These types of mechanically assisted reactions are called mechanochemical displacement reactions.

If one wishes to improve the corrosion resistance of the metal matrix in addition to precipitate the ceramic component, one may add to the powder mixture corrosion resistant elements such as Cr or Ta before milling the components. These additives are then inserted into the crystalline metal matrix by the high energy milling process to provide good corrosion resistance to the material. Since the high intensity milling process is a non-equilibrium process, it is possible to insert corrosion resistant elements into the matrix beyond the equilibrium solid solubility limit. Therefore, the crystalline matrix of the composite of the present invention is preferably a supersaturated metastable crystalline solid solution.

The milled powder thus formed containing a corrosion resistant metal matrix and ceramic nanoparticles, is then used in a thermal spray process to form a coating of the composite according to the invention. The size of the ceramic precipitates remains small even after deposition because recent thermal spray processes such as the high pressure high velocity oxy fuel process (HPHVOF) involves very rapid heating and cooling cycles which keeps the microstructure of the powders almost unchanged. In fact, melting of the powder during the thermal spray process is not recommended. The low temperatures and short thermal cycles in such processes do not allow the growth of the components. Without limitation, thermal spray processes covered within the scope of this invention are the HPHVOF, HPHVOF (high pressure, high velocity air fuel) and the Cold Spray processes. In such processes, the powder particles travel at very high speed, typically well above 500 m/s allowing fast quenching when the particles impact the substrate. However, if one wishes to modify the size distribution of the various components of the composite (metal-matrix and ceramic) to change the properties of the materials, one may apply a thermal annealing treatment on the powder prior to deposition or apply a post-thermal annealing treatment on the coating after deposition. One may also mill an annealed pre-synthesized powder to decrease the grain size of the precipitates. If the thermal spray process chosen to prepare the coatings uses a metal wire as feedstock instead of powders, the milled powder made by the method of the present invention can easily be transformed into a wire shape by any methods known in the prior art.

So, a first object of the present invention is a method of preparing a metal-ceramic composite material in the form of a coating.

More specifically, the invention is directed to a method of preparation of a metal-ceramic composite coating containing a metal component and a ceramic component, which consist of using a thermal spray technique and a powder which is fabricated by a mechanochemical displacement reaction to produce the ceramic component of the composite in-situ.

A second object of the present invention is the composite material made by the high energy mechanochemical reaction process described previously which has a corrosion resistant iron aluminide based metal matrix and very small ceramic particles well distributed within the metal matrix whose dimensions are in the nanometre range.

More specifically, the invention is directed to a metal-ceramic nanocomposite material of the following formula:

Fe₃₋ₓAl₁₊ₓM_{y}R_{z}

wherein

Fe₃₋ₓAl₁₊ₓ represents the iron-aluminide matrix

M represents at least one element in solution in the crystalline metal matrix which improves its corrosion resistance. Preferred elements are Cr, Mo, Ni, Nb, Si, Zr, Ta and Ti.

R represents the ceramic components comprising at least one boride, carbide, nitride, oxide, silicide, phosphide, sulfide and fluoride of the hard refractory metals of the group IV, V, and VI of the Periodic Table or of Fe, Al and M elements described herein above.

x is a number higher than −1 and smaller than or equal to +1

y and z are number between 0 and 1

In the above formula, 3−x, 1+x, y and z represent molar content of Fe, Al, M and R component respectively.

Said material advantageously has a ceramic component consisting of ceramic nanoparticles whose dimensions are below 100 nm.

A third object of the present invention is the use of the above mentioned metal-ceramic composite material as protective coatings for tribological applications.

### BRIEF DESCRIPTION OF THE DRAWINGS

FIG. 1 shows a X-ray diffraction spectrum of a powder mixture of Ti, BN and Al after 12 h of milling (upper spectrum) and the milled powder after a thermal treatment at 1000 C for 2 hours (lower spectrum).

FIG. 2 shows a X-ray diffraction spectrum of a powder mixture of Mo, BN and Al after 12 h of milling (upper spectrum) and the milled powder after a thermal treatment at 1000 C for 2 hours (lower spectrum).

FIG. 3 shows a X-ray diffraction spectrum of a powder mixture W, BN and Al after 12 h of milling (upper spectrum) and the milled powder after a thermal treatment at 1000 C for 2 hours (lower spectrum).

FIG. 4a) shows X-ray diffraction spectra of powder mixtures of iron aluminide (Fe3Al) and boron nitride (BN) after milling and thermal treatment for 2 h at 1000 C. Three molar fractions of Fe₃Al and BN are presented 90:10, 70:30 and 50:50.

FIG. 4b) shows X-ray diffraction spectra of 70% iron aluminide, 30% boron nitride molar fractions after milling and thermal treatment at 1000 C (lower spectrum) and 1300 C (upper spectrum).

FIG. 5 shows scanning electron micrographs of powders milled 10 hours for three different compositions a) 90% Fe₃Al, 10% BN, b) 70% Fe₃Al, 30% BN and c) 50% Fe₃Al, 50% BN.

FIG. 6 shows a micrograph of the cross-section of a coating according to the invention made by the HPHVOF thermal spray process using the powder shown in FIG. 5b).

FIG. 7 shows an X-ray diffraction spectrum of a powder mixture of 55% molar fraction of iron aluminide (Fe₃Al), 30% molar fraction of boron nitride (BN) and 15% molar fraction of Ti after milling and heat treatment at 1000 C for 2 h. The lower part shows a similar spectrum on a log scale to reveal the position of the TiB₂ and AlN peaks more precisely.

FIG. 8 a) shows a scanning transmission electron microscope (STEM) image of a powder mixture of 55% molar fraction of iron aluminide (Fe₃Al), 30% molar fraction of boron nitride (BN) and 15% molar fraction of Ti after 10 h of milling. FIG. 8 b) and c) show the corresponding Ti and B maps respectively.

FIG. 9 shows the dimensional wear coefficient of coatings made by HVOF thermal spray using the powders shown in FIG. 5.

FIG. 10 are thermogravimetric analysis (TGA) and differential thermal analysis (DTA) curves of powder mixtures with compositions Fe₃Al(70%)BN(30%) and Fe₃Al(55%)Ti(15%)BN(30%) mixed only [a) and c)] and milled 10 h [b) and d)].

FIG. 11 shows a Ti map taken on a scanning transmission electron microscope (STEM) of a powder mixture of 55% molar fraction of iron aluminide (Fe₃Al), 30% molar fraction of boron nitride (BN) and 15% molar fraction of Ti after 10h of milling.

### DETAILED DESCRIPTION OF THE INVENTION

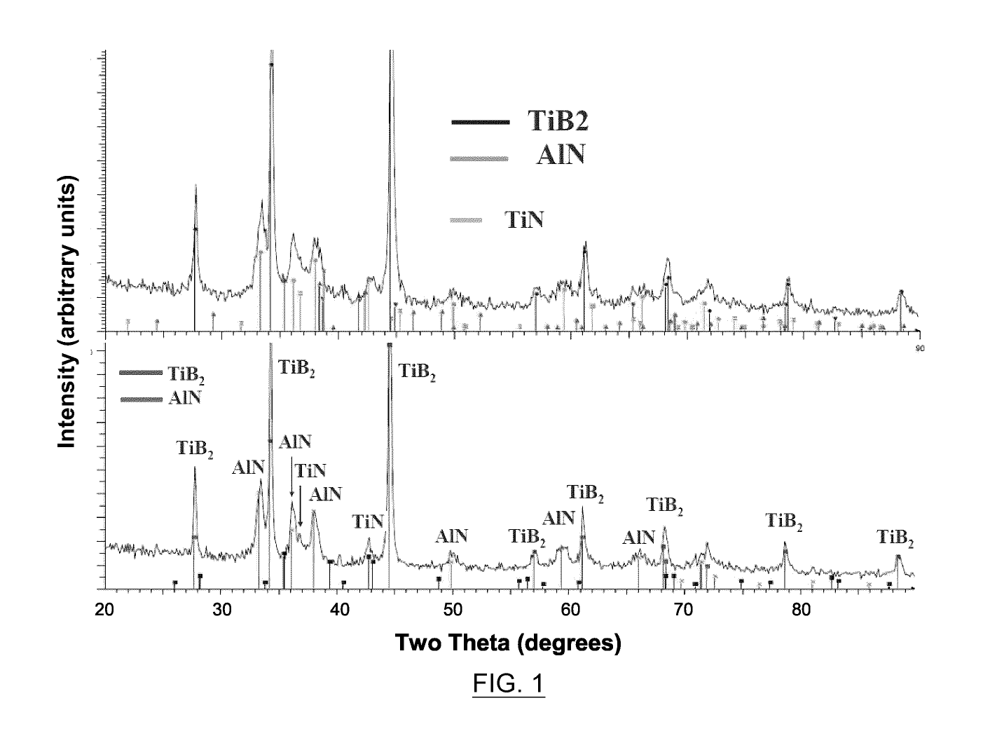

FIG. 1 shows a displacement reaction during a milling experiment leading to the formation of titanium diboride (TiB₂). A mixture of 1.638 g of BN, 1.781 g of Al and 1.581 g of Ti is milled intensively for 12 h in a steel crucible using a SPEX mill. The following reaction takes place 2BN+2Al+Ti=>TiB₂+2AlN. The upper x-ray diffraction spectrum shows the presence of TiB₂, AlN and some traces of TiN after milling. The peaks are very wide which means that the crystal sizes are extremely small. After thermal treatment at 1000 C for 2 hours (lower spectrum), the peaks are better defined and more narrow indicating that crystal growth took place during annealing.

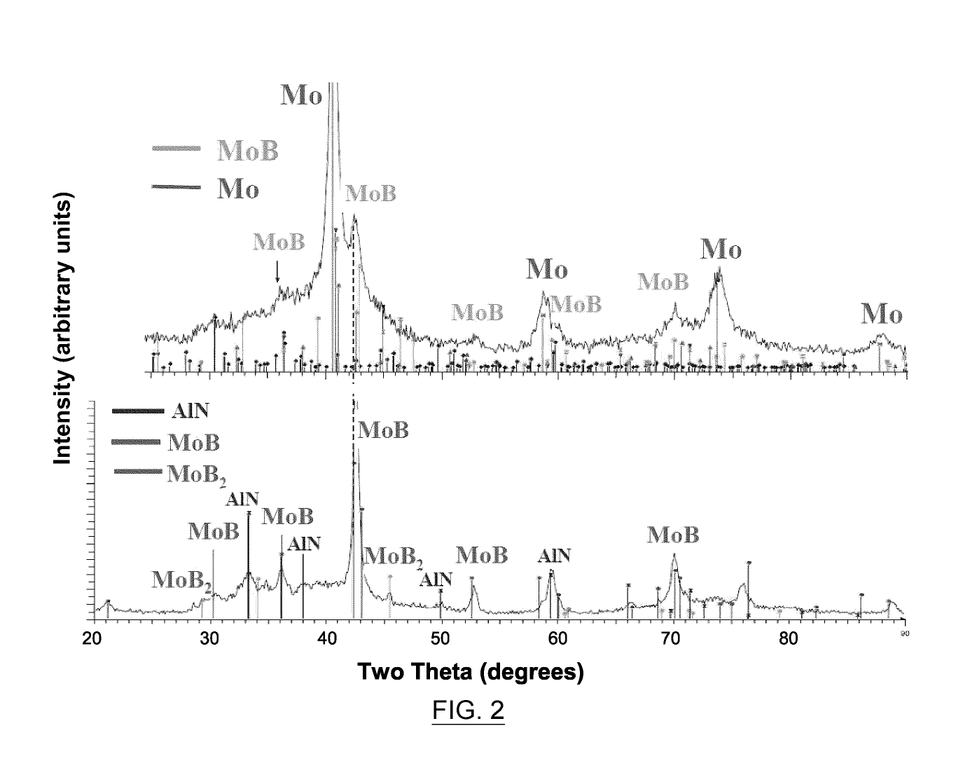

FIG. 2 shows a similar displacement reaction but this time with Mo instead of Ti. A mixture of 0.840 g of BN, 0.9130 g of Al and 3.247 g of Mo is milled intensively for 12 h in a steel crucible. The following reaction takes place BN+Al+Mo=>MoB+AlN. The upper x-ray diffraction spectrum shows the presence of metallic Mo and MoB. AlN is not detected after milling. The displacement reaction is not fully completed. The peaks are very wide and there is a large background indicating a high level of disorder and a very fine microstructure. After thermal treatment at 1000 C for 2 hours, the peaks of MoB and AlN are well defined, no residual Mo is observed and some traces of MoB₂ may be present (lower spectrum).

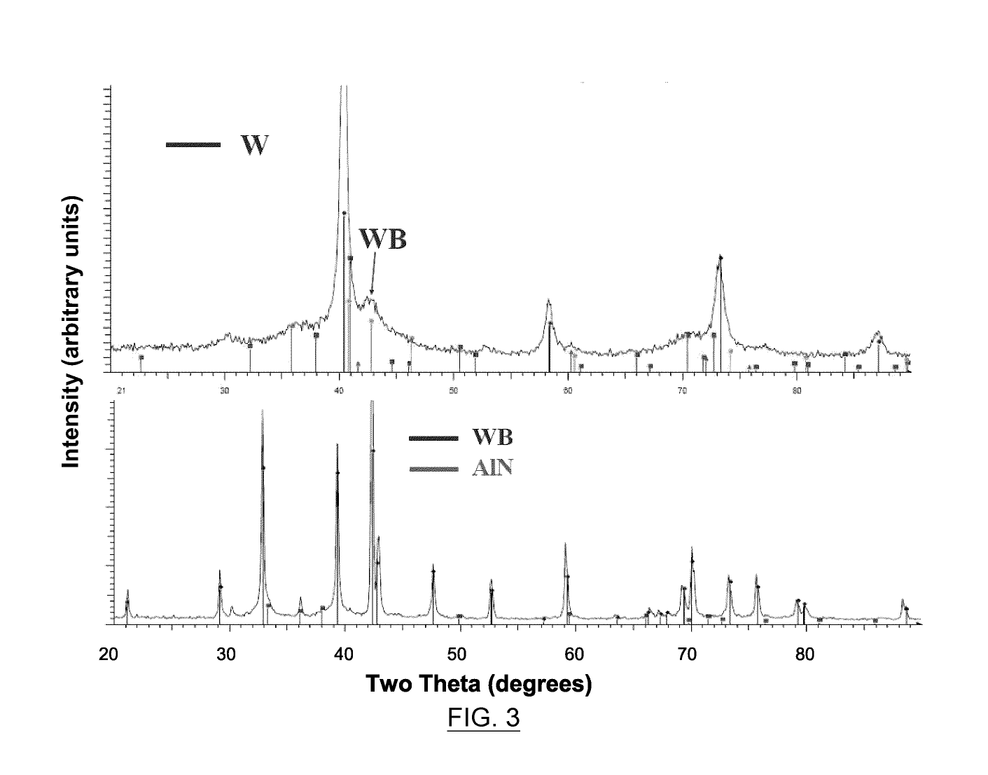

FIG. 3 shows a third example of a displacement reaction with W to form WB as ceramic component of the composite. A mixture of BN, Al and W is milled intensively for 12 h and the following reaction takes place BN+Al+W=>WB+AlN during milling. The upper x-ray diffraction spectrum shows some traces of WB after milling but metallic W is still present in large quantity. AlN is not detected after milling. After thermal treatment at 1000 C for 2 hours (lower spectrum), the peaks of WB and AlN are sharp and well defined. No residual W is observed after annealing which indicates that the conversion into WB is fully completed.

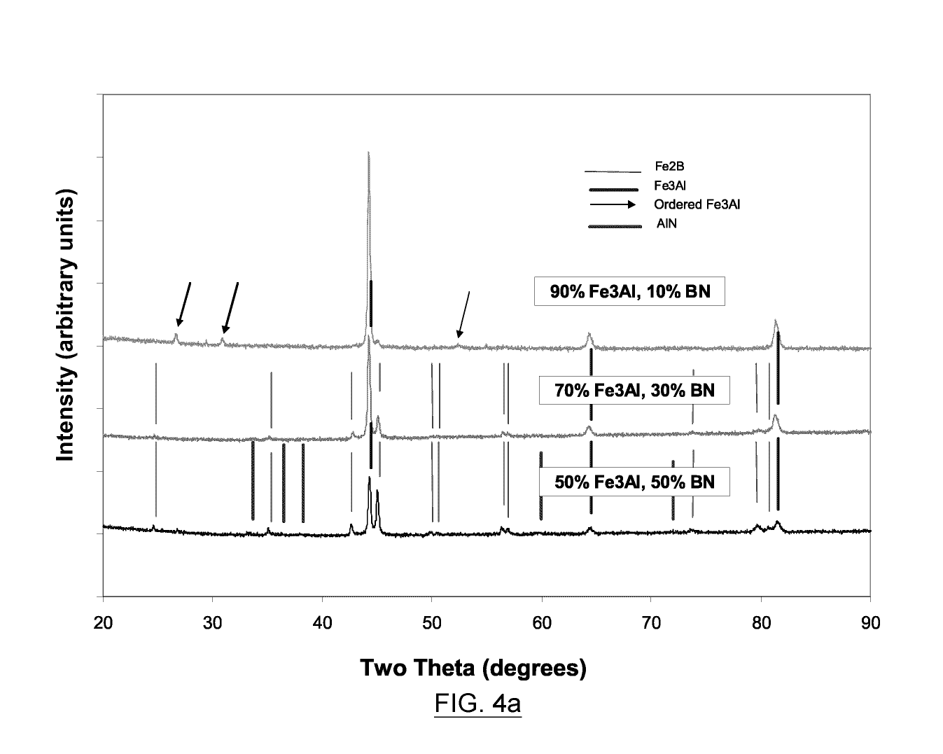

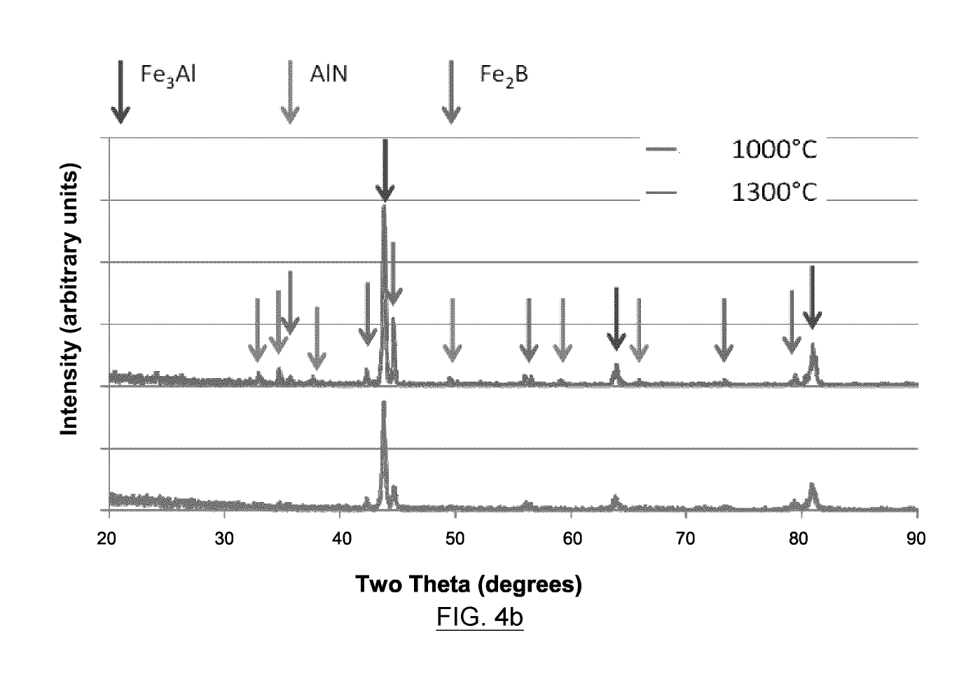

FIG. 4 shows examples of materials containing no added refractory metal. Only iron aluminide and boron nitride are present. Three molar fractions are presented in FIG. 4 a) 90% Fe₃Al and 10% BN, 70% Fe₃Al and 30% BN and 50% Fe₃Al and 50% BN. The x-ray diffraction spectra are presented after milling and thermal treatment at 1000 C for 2 hours. The data indicate clearly the formation of iron boride (Fe₂B) during the process. Some traces of AlN are discernable in the 50:50 composition but the peaks are very small. When the thermal treatment is performed at higher temperature 1300 C for 2 h instead of 1000 C for 2 h on a sample of 70:30 composition (see FIG. 4b)), the peaks of AlN are much more distinguishable.

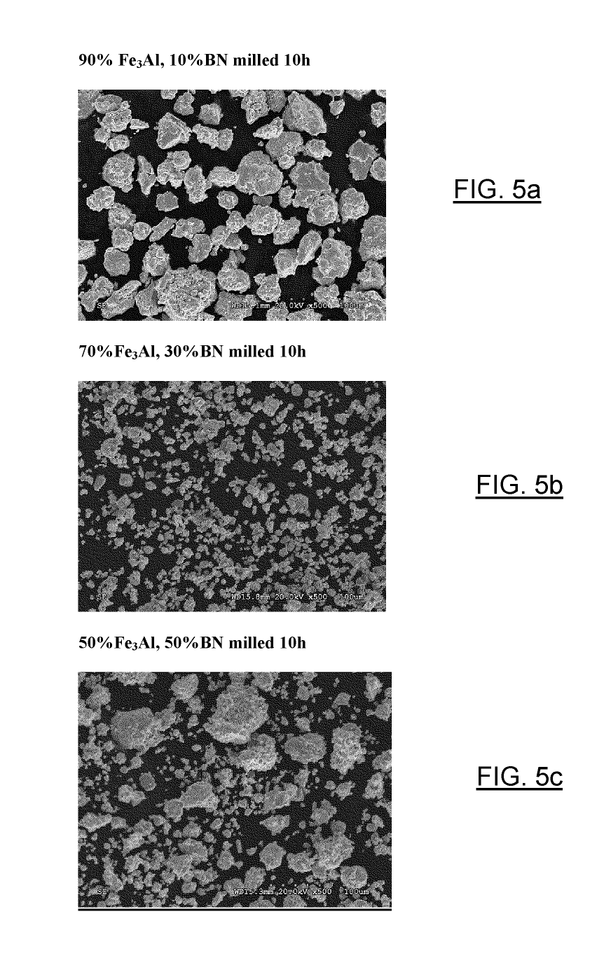

FIG. 5 shows scanning electron micrographs of 10 h milled powders with three different BN content: a) 90% Fe₃Al, 10% BN, b) 70% Fe₃Al, 30% BN and c) 50% Fe₃Al, 50% BN. No refractory metal was added in these materials. One can see clearly that the increase of the molar fraction of BN from 10 to 30% leads to a significant refining of the powder particles. However when the BN content increases further to 50%, agglomeration of the powder into very large particles takes place and a very broad distribution of particle size is observed.

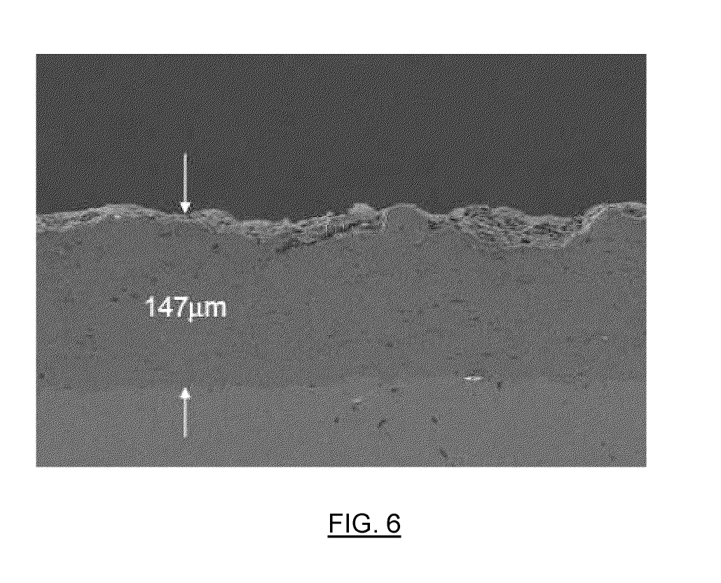

FIG. 6 is showing a micrograph of the cross-section of a coating according to the invention made by the HPHVOF thermal spray process. The powder used to prepare this coating was milled 10 h and had a composition 70% Fe₃Al:30% BN. The thickness of the coating is about 150 μm.

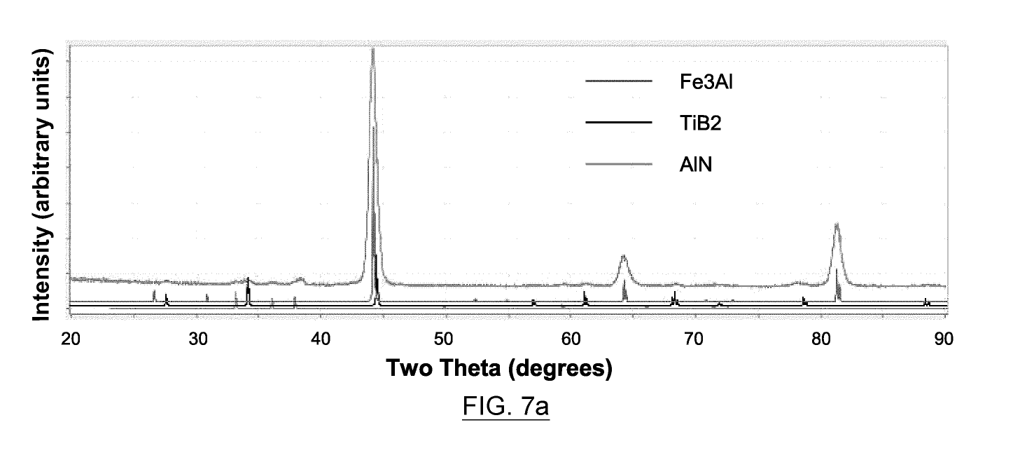

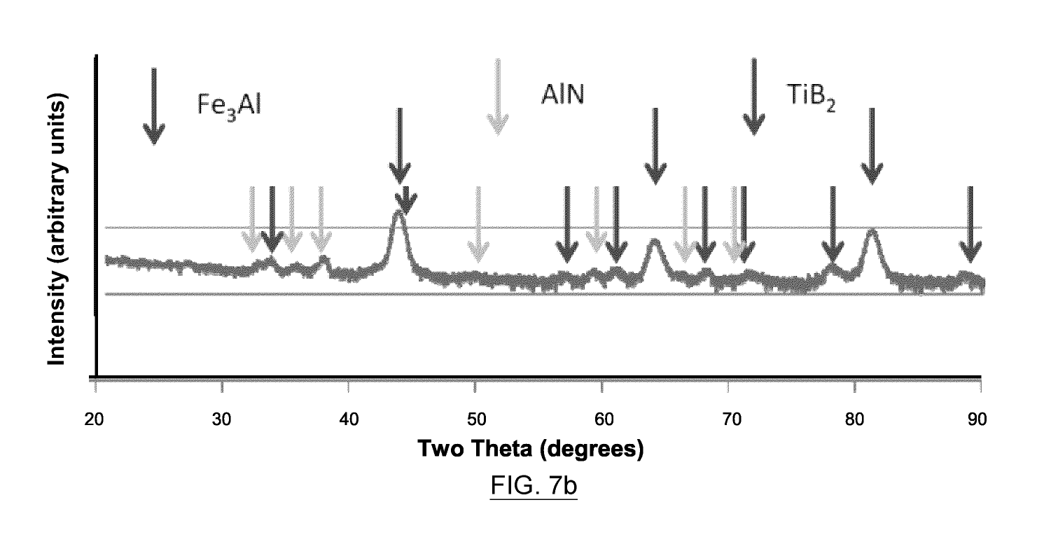

FIG. 7 shows an example of a material according to the invention containing a refractory metal. Iron aluminide, titanium and boron nitride are considered in this example. The molar fractions are 55% Fe₃Al, 15% Ti and 30% BN. The x-ray diffraction spectrum is presented after milling and thermal treatment at 1000 C for 2 hours. The lower figure shows a similar spectrum on a log scale to reveal in more details the small peaks in the data. The results indicate clearly the formation of titanium diboride (TiB₂) during the process instead of iron boride (Fe₂B) as in the case shown in FIG. 4 when no Ti is present in the material.

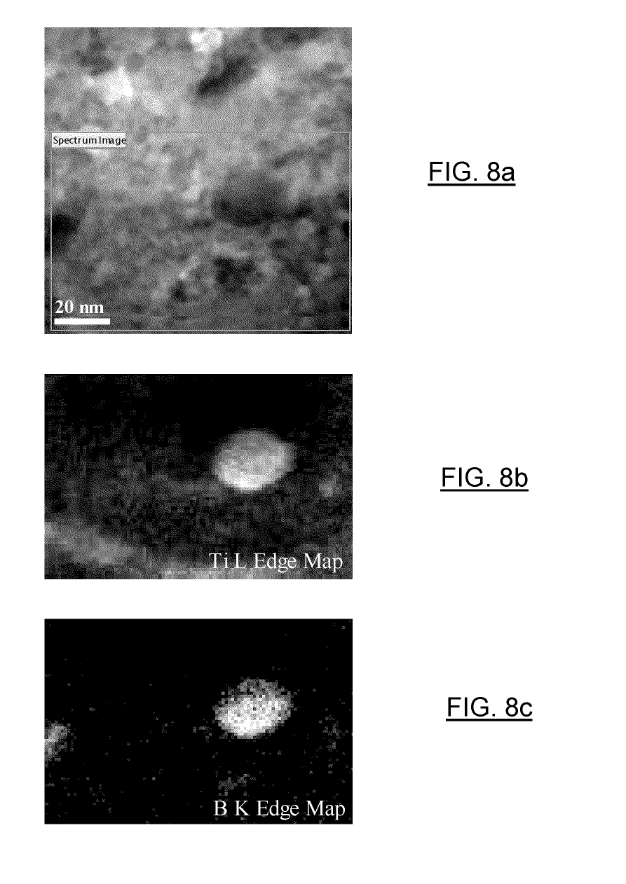

FIG. 8a) is a scanning transmission electron microscope (STEM) image showing the nanostructure of a ball milled powder of 55% Fe₃Al, 30% BN and 15% Ti after 10 h of milling. FIG. 8b) and c) show the corresponding Ti and B maps indicating the presence of a titanium diboride nanocrystal formed by a mechanochemical displacement reaction. The size of the ceramic precipitate in this material is about 20 nm.

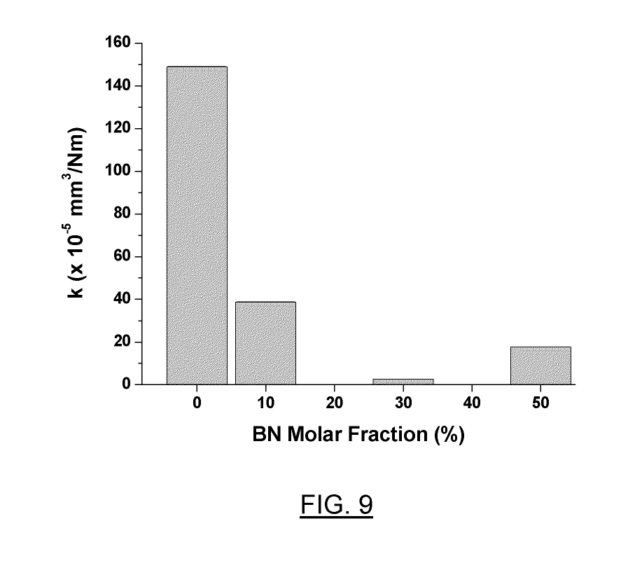

FIG. 9 shows the wear rate of coatings made by HVOF thermal spray using the powders shown in FIG. 5. The addition of 30% of BN to the iron-aluminide matrix (Fe₃Al) to form a ceramic component of iron boride and aluminium nitride (Fe₂B+AlN) in the composite leads to a significant decrease in the wear rate. However if the BN content increases to 50%, the wear properties degrade significantly. This phenomenon is probably related to the agglomeration process discussed previously and shown in FIG. 5c.

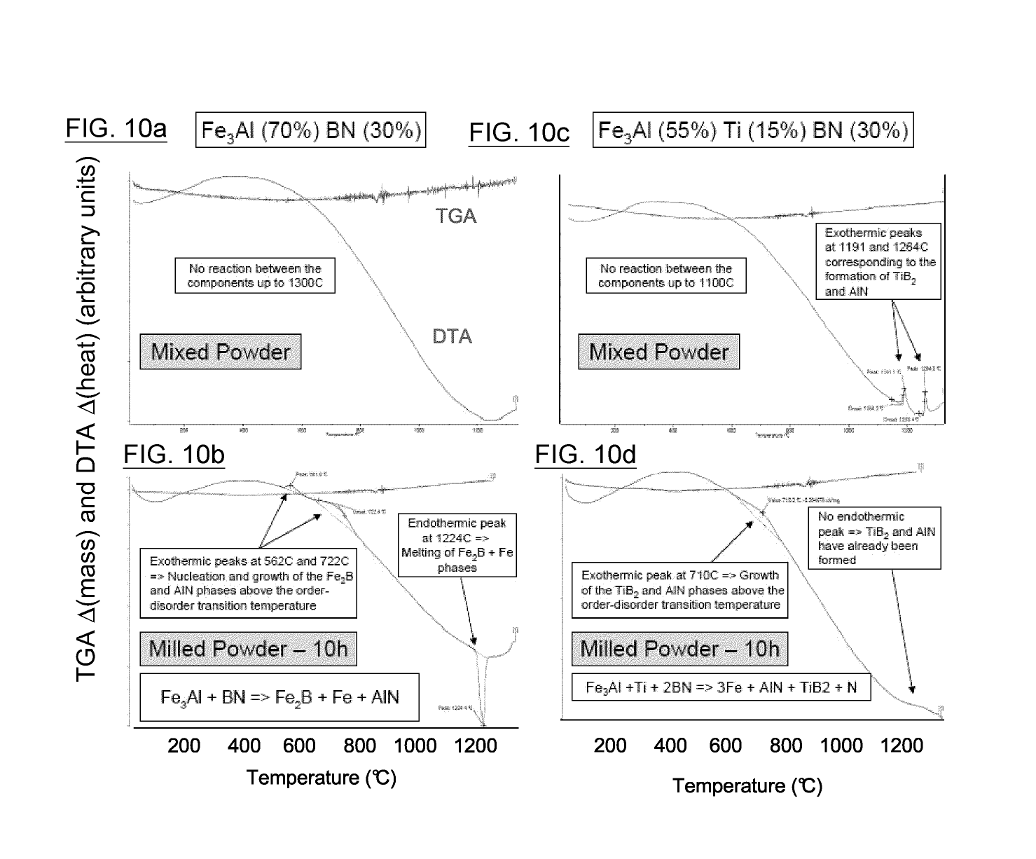

FIG. 10 are thermogravimetric analysis (TGA) and differential thermal analysis (DTA) curves of powder mixtures with compositions Fe₃Al(70%)BN(30%) and Fe₃Al(55%)Ti(15%)BN(30%) mixed only [a) and c)] and milled 10 h [b) and d)] prior to start the heating experiments. These results show clearly that after high energy milling, the ceramic components in these systems grow more efficiently than if they were formed by the thermal processes of the prior art such as the SHS reactions to synthesize the ceramic precipitates where only mixing of the powders is performed. The mechanochemical reactions allow the nucleation of the ceramics and provide a nanostructure that maximizes the reaction rates of the different phases in part because of the large interface area.

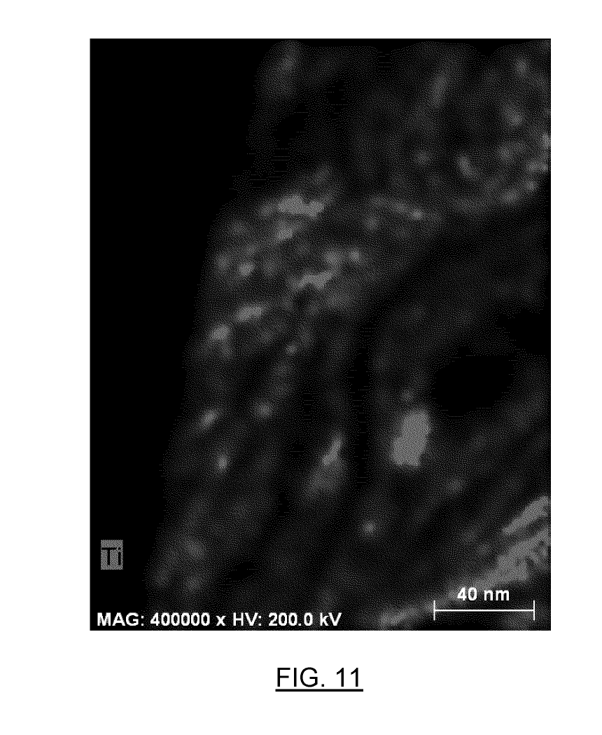

FIG. 11 shows a Ti map taken at very high magnification on a scanning transmission electron microscope (STEM) of a powder mixture of 55% molar fraction of iron aluminide (Fe₃Al), 30% molar fraction of boron nitride (BN) and 15% molar fraction of Ti after 10 h of milling in a high energy ball mill. The picture indicates that most of the Ti clusters or nanocrystals have a size smaller than 10 nm.

1-56. (canceled)

57. A method of preparing a metal-ceramic composite coating for tribological applications, the metal-ceramic composite coating containing a metal component based on an iron aluminide alloy and comprising at least one element in solution in the metal matrix selected from the group consisting of Cr, Mo, Nb, Si, Zr, Ta and Ti, and a ceramic component, the method comprising using a thermal spray technique and a composite powder which is fabricated by a mechanochemical displacement reaction to produce the ceramic component of the composite powder in-situ.

58. The method according to claim 57, wherein the metal component of the composite comprises at least one further metal in addition to the iron aluminide alloy.

59. The method according to claim 57, wherein the ceramic component of the composite comprises at least one boride, carbide, nitride, oxide, fluoride, silicide, phosphide and sulfide.

60. The method according to claim 57, wherein the mechanochemical displacement reaction takes place between at least one element selected from the group of Fe and Al and at least one non-metal element selected from the group consisting of B, C, N, O, F, Si, P and S.

61. The method according to claim 60, wherein the mechanochemical displacement reaction takes place between Fe and B to form Fe₂B as the ceramic component.

62. The method according to claim 57, wherein the mechanochemical displacement reaction takes place between at least one refractory hard metal of the group IV, V and VI of the Periodic Table and at least one non-metal element selected from the group consisting of B, C, N, O, F, Si, P and S.

63. The method according to claim 62, wherein the mechanochemical displacement reaction takes place between Ti and B to produce TiB₂ as the ceramic component.

64. The method according to claim 62, wherein the at least one non-metal element is introduced into the composite by the use of a solid lubricant.

65. The method according to claim 64, wherein the solid lubricant is selected from the group consisting of BN, graphite, graphite fluoride, fullerene, MoS₂, WS₂, CaF₂, CeF₃, talc and PTFE.

66. The method according to claim 57, wherein the thermal spray technique comprises a high pressure high velocity oxy fuel process, a high pressure, high velocity air fuel process, or a Cold Spray process.

67. A metal-ceramic nanocomposite material represented by the following formula:
Fe₃₋ₓAl₁₊ₓM_{y}R_{z}
wherein
Fe₃Al₁₊ₓ represents an iron-aluminide metal matrix;
M represents at least one element in solution in the metal matrix selected from the group consisting of Cr, Mo, Nb, Si, Zr, Ta and Ti;
Fe₃₋ₓAl₁₊ₓM_{y} represents a metal component of the nanocomposite material;
R represents a ceramic component comprising at least one boride, carbide, nitride, oxide, silicide, phosphide, sulfide and fluoride of the hard refractory metals of the group IV, V, and VI of the Periodic Table, or of Fe, Al and M elements described herein above;
x is a number higher than −1 and smaller than or equal to +1;
y and z are numbers higher than 0 and smaller than or equal to 1;
3−x, 1+x, y and z represent molar content of Fe, Al, M and R respectively;
said material having a ceramic component consisting of ceramic nanoparticles whose dimensions are below 100 nm.

68. The metal-ceramic nanocomposite material according to claim 67, wherein the ceramic nanoparticles have dimensions below 10 nm.

69. The metal-ceramic nanocomposite material according to claim 67, which is obtained by a mechanochemical displacement reaction.

70. The metal-ceramic nanocomposite material according to claim 67, wherein the metal matrix is a supersaturated metastable crystalline solid solution.

71. A method of preparing a metal-ceramic composite coating that includes an iron aluminide alloy based metal component and a ceramic component, the method comprising:
providing a powder mixture comprising iron aluminide and non-metals;
milling the powder mixture to induce mechanochemical displacement reactions and enable in-situ precipitation of the ceramic component that includes the non-metals, to produce a composite powder; and
spraying the composite powder or a composite material derived from the composite powder, onto a substrate to form the metal-ceramic composite coating.

72. The method according to claim 71, wherein the non-metals include a boron compound, and the ceramic component comprises a metal-boron compound comprising TiB₂, Fe₂B or a combination thereof.

73. The method according to claim 71, wherein the iron aluminide in the powder mixture provides a source of iron for producing the ceramic component.

74. The method according to claim 71, wherein the powder mixture further comprises a refractory hard metal of the group IV, V and VI of the Periodic Table.

75. The method according to claim 71, wherein the refractory hard metal provides a source of metal for producing the ceramic component.

76. The method according to claim 75, wherein the powder mixture comprises a solid lubricant.

77. The method according to claim 76, wherein the solid lubricant comprises the non-metals comprising boron nitride, graphite, graphite fluoride, fullerene, molybdenum disulfide, tungsten disulfide, calcium fluoride, cerium fluoride, talc, and/or polytetrafluoro ethylene.

78. The method according to claim 77, wherein the solid lubricant comprises boron nitride, and wherein the boron nitride is present in the powder mixture in a concentration of 10% to 50% on a molar basis.

79. The method according to claim 71, wherein the powder mixture further comprises a corrosion resistant element comprising Cr or Ta.

80. The method according to claim 79, wherein the corrosion resistant element is added prior to the milling step, and in an amount beyond an equilibrium solid solubility limit, the powder composite thereby having a crystalline matrix comprising a supersaturated metastable crystalline solid solution

81. The method according to claim 71, wherein the spraying is performed at temperatures so as to avoid melting of the composite powder and to avoid crystal growth.

82. The method according to claim 71, wherein the metal-ceramic composite coating comprises a metal-ceramic nanocomposite material represented by the following formula:
Fe₃₋ₓAl₁₊ₓM_{y}R_{z}
wherein
Fe₃₋ₓAl₁₊ₓ represents a matrix of the iron aluminide metal;
M represents at least one element in solution in the iron aluminide metal matrix selected from the group consisting of Cr, Mo, Nb, Si, Zr, Ta and Ti;
Fe₃₋ₓAl₁₊ₓM_{y} represents a metal component of the nanocomposite material;
R represents a ceramic component comprising at least one of boride, carbide, nitride, oxide, silicide, phosphide, sulfide and fluoride of the hard refractory metals of the group IV, V, and VI of the Periodic Table, or of Fe, Al and M elements;
x is a number higher than −1 and smaller than or equal to +1;
y and z are numbers higher than 0 and smaller than or equal to 1; and
3−x, 1+x, y and z represent molar content of Fe, Al, M and R respectively.
